(19) United States
(12) Patent Application Publication
(10) Pub. No.: US 2008/0137490 A1
(43) Pub. Date: Jun. 12, 2008

(54) OPTICAL DISC WITH ANGULAR INFORMATION AND SYSTEM FOR DETECTING ANGULAR INFORMATION AND RELATED METHOD THEREOF

(76) Inventor: Fung-Hsu Wu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/747,923

(22) Filed: May 14, 2007

(30) Foreign Application Priority Data
Dec. 8, 2006 (TW) 095146172

(51) Int. Cl. G11B 7/00

(52) U.S. Cl. 369/44.13

(57) ABSTRACT

Disclosed is an optical disc having angular information and a wobble track. A wobble signal generated according to the wobble track includes a phase corresponding to an angle of the optical disc. A detecting system for detecting the angular information of the optical disc is also disclosed, which includes a wobble signal detecting apparatus, a reference clock signal generating apparatus, and a phase comparator. The wobble signal detecting apparatus is used for detecting the wobble track on the optical disc to generate a wobble signal. The reference clock signal generating apparatus is used for generating a reference clock signal according to the wobble signal. The phase comparator is used for comparing the wobble signal and the reference clock signal to obtain the angular information of the optical disc. Alternatively, the wobble signal detecting apparatus can be used for detecting the wobble signal on the optical disc.

### BACKGROUND OF THE INVENTION

1. Field of the Invention

The present invention relates to an optical disc, a related detection system and a method thereof, and particularly relates to an optical disc with angular information, a system for detecting angular information and a method thereof.

2. Description of the Prior Art

In modern society, a pressing problem of information fields is how to arrange large amounts of information. Among all kinds of storage media, an optical disc has became the most popular high capacity data storage medium due to its thinness and high-density storage capacity. Also, the invention of CD-R, CD-RW, DVD±R, and DVD±RW for optical disc has ensured its importance as a storage medium.

Regions for storing data on a CD are divided into many small frames for the convenience of arranging stored data, where the stored data on the optical disc is stored to the storing frames via specific rules. An optical disc burner must check the specific rules of the recording frames on the optical disc when data is written to a writable optical disc, such that the data can be written to the writable optical disc correctly. In order to record information about each recording region, the writable optical disc has specific structures for recording related information. Conventionally, the recording regions are classified into minute/second/frame regions, wherein a one-minute region is equal to 60 seconds, and one-second is equal to 75 frames. The information about recording frames is called ATIP (Absolute Time In Pre-groove).

FIG. 1 illustrates track structures of a prior art optical disc 100. As known by persons skilled in the art, an optical disc 100 has a reflection surface 103, which is disclosed in FIG. 1. The optical head emits laser light when the optical disc is put into the optical disc burner, such that the laser light will be modulated by different reflection modes of different parts of the reflection surface 103 and be reflected to the optical head, thereby enabling the optical disc burner to read information corresponding to the reflection mode. Additionally, the reflection surface 103 includes long track 101 around the circular center of the optical disc 100 and along the arc of the optical disc 100. Please refer to FIG. 1A, which illustrates an amplified figure of one part of the track 101. In a writable optical disc, the track 101 can be classified into two kinds of tracks. A first kind is a data track 102 for recording data, and the second kind is a wobble track 104 for recording information about the frames on the optical disc 100. The data track 102 is similar to the track 101, which is around the circular center of the optical disc 100 and along the arc of the optical disc 100. Since FIG. 1A is an amplified diagram of a tiny part of the arc track, the data track 102 is a straight line. According to the illustration of FIG. 1, the wobble track 104 is also an arc line around the circular center of the optical disc 100 and along the arc of the optical disc 100. According to the illustration of FIG. 1A, the wobble track 104 is a swinging line that swings about an amplitude along the arc line (which is a straight line) as in the data track 102 shown in FIG. 1A. The curve line of the wobble track 104 is composed of curves with two different periods (that is, the periods D1 and D2 shown in FIG. 1A).

FIG. 1B is a further amplified figure of the data track 102 and the wobble track 104. The data track 102 has un-continuous recording marks 106, which have different lengths and different reflection characteristics with the reflection surface 103. Un-continuous recording marks 106 with different lengths indicate different data information. The optical disc 100 can record various kinds of data written into the optical disc 100 by controlling the length of recording marks. On the other hand, the wobble track 104 for recording the information of the optical disc recording region protrudes from the continuous track of the reflection surface 103. Normally, the wobble track 104 protrudes from the reflection surface 103, and the data track 102 is located in the grooves formed by the protruded wobble tracks 104.

The wobble track 104 is produced on the disc to provide ATIP disc track information when the writable optical disc 100 is produced, such that disc location can be correctly determined when the optical disc burner reads or writes the disc information. Also, ATIP is generated according to the wobble track 104 via frequency modulation (FM), and address information is obtained after the wobble signal from the wobble track 104 is demodulated.

FIG. 2 illustrates a prior art optical head system 200. As shown in FIG. 2, the detecting system 200 includes detectors 201, 203, 205 and 207, amplifiers 209 and 211, a comparator 213, an equalization high pass filter 215, a level comparator 219, a phase comparator 217 and a frequency generator 221. Detectors 201, 203, 205 and 207 are used for detecting wobble signals on the optical disc 223, and the detection result would be transmitted to the amplifiers 209 and 211. Next, the comparator 213 is utilized to compare amplified detecting results, the equalization high pass filter 215 and the level comparator 219 are utilized to process results, and the phase comparator 217 is utilized to compare the processed comparing results with the reference frequency signal RCLK of the frequency generator 221, such that the signal error on the optical disc can be obtained. The detailed operation and structure of the detecting system 200 is well known by persons skilled in the art, and is thus omitted for brevity.

HP has disclosed a technique named Lightscribe, which burns patterns on the printed side of a CD-R. However, focus or tracking in such a technique is an open loop, and a bar code in the optical disc is necessary when angular information is desired to be determined. Furthermore, an optical disc driver needs extra elements for detecting signals.

Therefore, a new invention is needed to solve the above-mentioned problems.

### SUMMARY OF THE INVENTION

One objective of the present invention is to provide an optical disc, which has another wobble track on the printed side thereof. The wobble track has different coding method and purpose from ATIP. If angular information is added to the wobble track, the utilization of the bar code of a Lightscribe optical disc can be omitted, and the center of the optical disc driver does not need an extra element to detect a signal.

One embodiment of the present invention discloses an optical disc comprising angular information and a wobble track. The wobble signal generated according to the wobble track includes a phase corresponding to an angle of the optical disc, wherein the starting point of the wobble signal corresponds to different phases. Also, the stamper of the optical disc is preferably generated by exposing, developing and etching a substrate having photo resistance thereon when the substrate is rotated to a specific angle via a stepping motor.

Another embodiment of the present invention discloses a detecting system for detecting angular information of an optical disc, comprising:

a wobble signal detecting apparatus, for detecting a wobble track of the optical disc to generate a wobble signal; a reference clock signal generating apparatus, coupled to the wobble signal detecting apparatus, for generating a reference clock signal according to the wobble signal; and a phase comparator, coupled to the wobble signal detecting apparatus and the reference clock signal generating apparatus, for comparing the wobble signal and the reference clock signal to obtain the angular information of the optical disc. Alternatively, the wobble signal detecting apparatus detects a wobble signal on the optical disc (for example, an optical head).

Another embodiment of the present invention discloses a detecting method for detecting angular information of an optical disc, comprising: detecting a wobble track of the optical disc to generate a wobble signal; generating a reference clock signal according to the wobble signal; and comparing the wobble signal and the reference clock signal to obtain the angular information of the optical disc.

According to the above-mentioned detecting system and method, the angular information can be obtained according to stable wobble signals for other applications.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates track structures of a prior art optical disc.

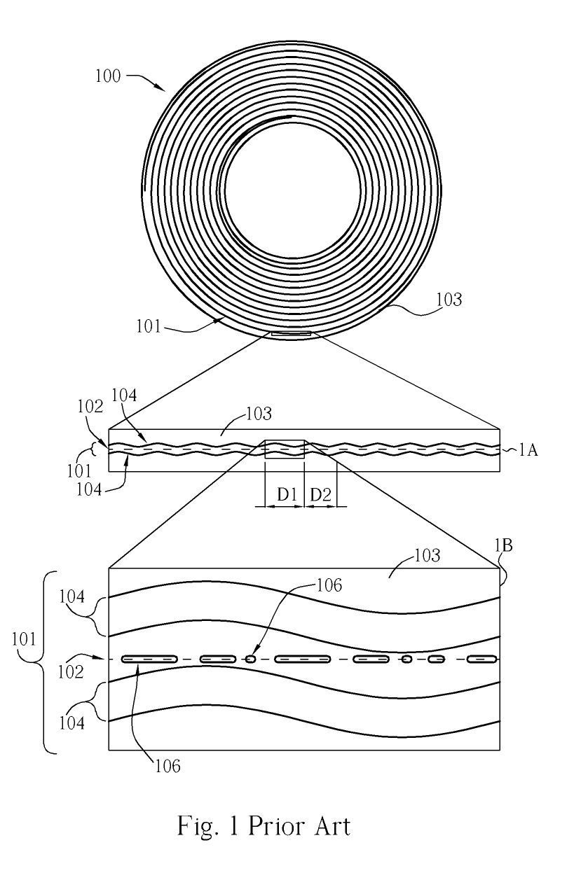

FIG. 2 illustrates a prior art optical head system.

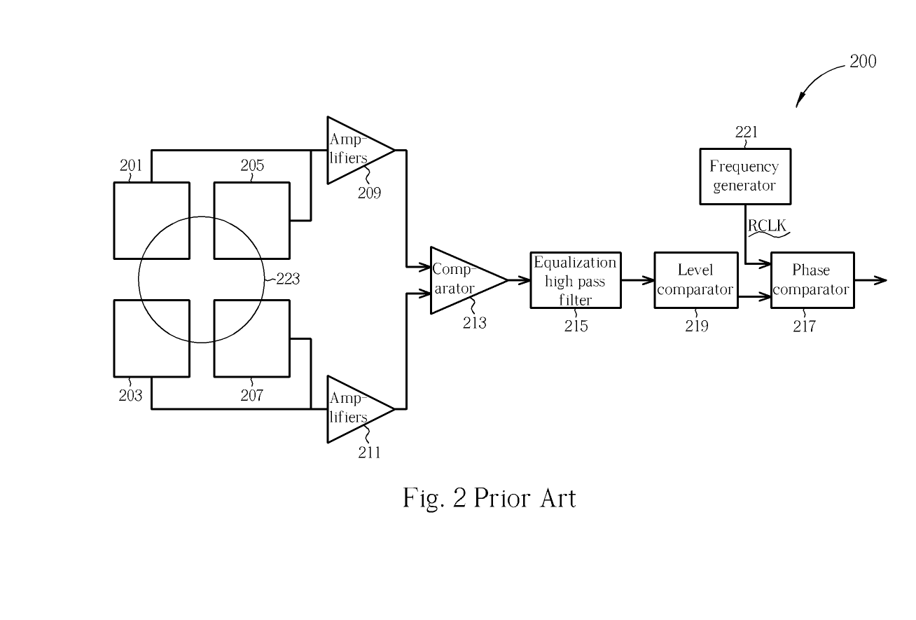

FIG. 3 illustrates a detecting system for detecting angular information of an optical disc according to an embodiment of the present invention.

FIG. 4 is a schematic diagram illustrating the operation of the detecting system for detecting angular information of an optical disc shown in FIG. 3.

FIG. 5 illustrates a wobble signal on the optical disc with angular information according to the present invention.

FIG. 6 is a flow chart of a method corresponding to the detecting system shown in FIG. 3.

### DETAILED DESCRIPTION

The present invention provides an optical disc, which has another wobble track on the printed side thereof. A wobble signal generated according to the wobble track has a phase corresponding to an angle. Also, the starting point of the wobble signal corresponds to an angle. Such kind of optical disc is made from a stamper with angular information. The stamper is preferably generated by exposing, developing and etching a substrate having photo resistance thereon when the substrate is rotated to a specific angle via a motor.

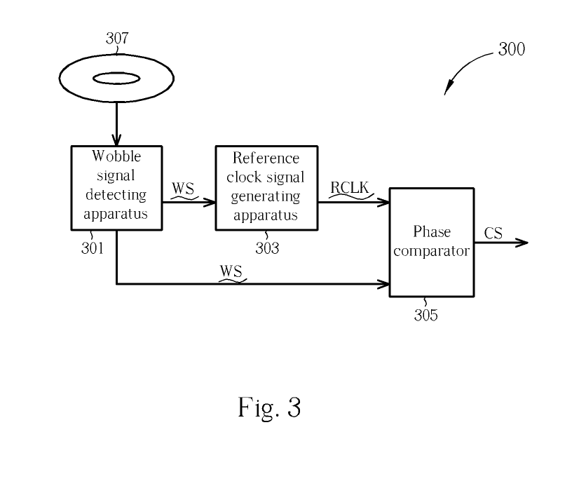

FIG. 3 illustrates a detecting system 300 for detecting angular information of an optical disc according to an embodiment of the present invention. As shown in FIG. 3, the detecting system 300 comprises a wobble signal detecting apparatus 301, a reference clock signal generating apparatus 303 and a phase comparator 305. The wobble signal detecting apparatus 301 is used for detecting a wobble track of the optical disc 307 to generate a wobble signal WS. The reference clock signal generating apparatus 303, which is coupled to the wobble signal detecting apparatus 301, is used for generating a reference clock signal RCLK according to the wobble signal WS. The phase comparator 305, which is coupled to the wobble signal detecting apparatus 301 and the reference clock signal generating apparatus 303, is used for comparing the wobble signal WS and the reference clock signal RCLK to obtain a comparing result CS, which can provide angular information of an optical disc. It should be noted that the wobble signal detecting apparatus 301 can be used only for detecting the wobble signal on the optical disc, and the wobble signal can be generated on the optical disc 307 by other optical devices, such as an optical head. Since the method for detecting or generating the wobble signal WS, the method for generating the reference clock signal RCLK and the method of comparing the reference clock signal RCLK and the wobble signal WS to obtain the comparing result CS are well-known by persons skilled in the art, they are omitted here for brevity.

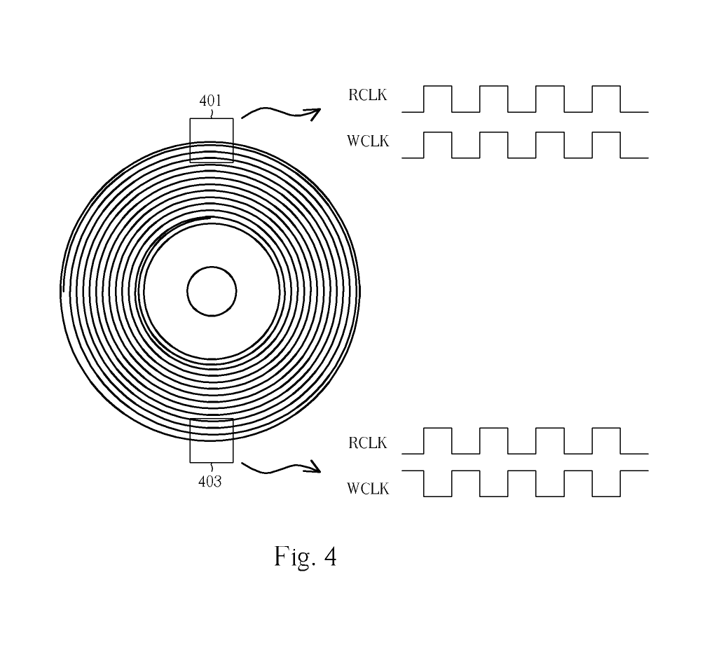

FIG. 4 is a schematic diagram illustrating the operation of the detecting system 300 for detecting angular information of an optical disc shown in FIG. 3. The step for obtaining angular information of an optical disc according to the comparing result CS can be understood through FIG. 4. In FIG. 4, the wobble signal WS is converted to a wobble clock WCLK first and then compared, but this is not meant to limit the scope of the present invention.

As shown in FIG. 4, the reference clock signal RCLK has the same phase as the wobble clock WCLK in region 401. Thus the optical rotation angle is determined to be 0° if the comparing result CS indicates that the reference clock signal RCLK has the same phase as the wobble clock WCLK. There is a phase difference π between the reference clock signal RCLK and the wobble clock WCLK in region 403, however. Thus the optical rotation angle is determined to be π if the comparing result CS indicates that the reference clock signal RCLK has a phase difference π from the wobble clock WCLK. As described above, the angular information of the optical disc can be obtained by comparing the phases of the reference clock signal RCLK and the wobble clock WCLK.

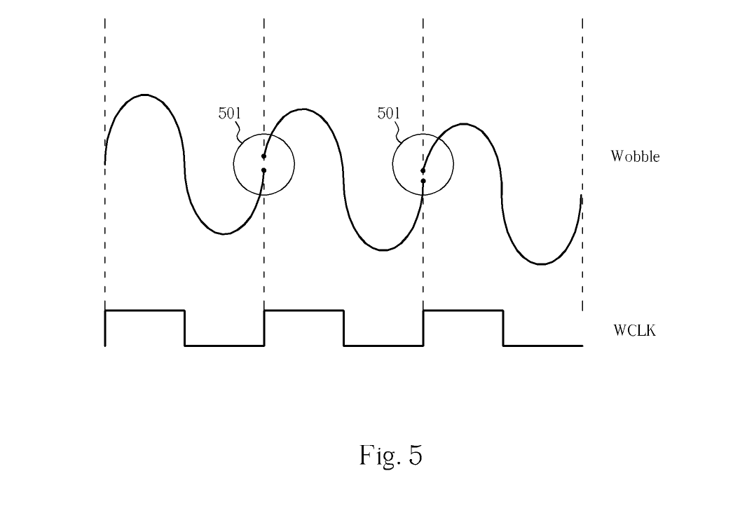

FIG. 5 illustrates a wobble signal on the optical disc with angular information according to the present invention. As shown in FIG. 5, the wobble signal has different phases for each period starting point 501, and the wobble clock WCLK is generated according to the periods of the wobble signal. Since the determining method of the starting and ending of the wobble signal is well known by persons skilled in the art, it is omitted here for brevity.

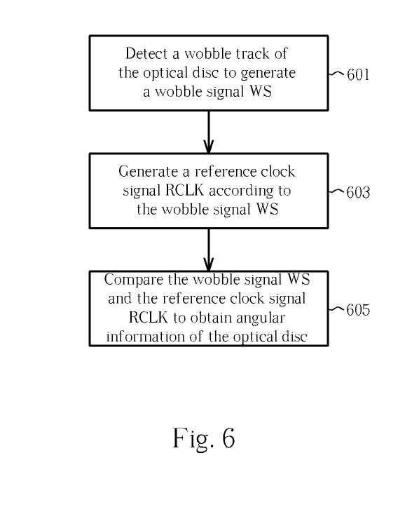

FIG. 6 is a flow chart of a method corresponding to the detecting system 300 shown in FIG. 3. The method comprises:

Step 601: Detect a wobble track of the optical disc to generate a wobble signal WS.

Step 603: Generate a reference clock signal RCLK according to the wobble signal WS.

Step 605: Compare the wobble signal WS and the reference clock signal RCLK to obtain angular information of the optical disc.

As described above, step 601 can be replaced by detecting the wobble signal WS on the optical disc generated by other devices, and this also falls in the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical disc with angular information, comprising a wobble track, wherein a wobble signal generated according to the wobble track includes a phase corresponding to an angle of the optical disc.

2. The optical disc of claim 1, wherein a starting point of the wobble signal corresponds to the phase.

3. The optical disc of claim 1, being generated from a stamper having angular information.

4. The optical disc of claim 3, wherein the stamper is generated by exposing, developing and etching a substrate having photo resistance thereon when the substrate is rotated to a specific angle via a stepping motor.

5. A detecting system for detecting angular information of an optical disc, comprising:
a wobble signal detecting apparatus, for detecting a wobble track of the optical disc to generate a wobble signal;
a reference clock signal generating apparatus, coupled to the wobble signal detecting apparatus, for generating a reference clock signal according to the wobble signal; and
a phase comparator, coupled to the wobble signal detecting apparatus and the reference clock signal generating apparatus, for comparing the wobble signal and the reference clock signal to obtain the angular information of the optical disc.

6. The detecting system of claim 5, wherein the wobble signal includes a phase corresponding to an angle of the optical disc.

7. The detecting system of claim 6, wherein a starting point of the wobble signal corresponds to the phase.

8. The detecting system of claim 6, wherein the optical disc is generated from a stamper having the angular information.

9. The detecting system of claim 8, wherein the stamper is generated by exposing, developing and etching a substrate having photo resistance thereon when the substrate is rotated to a specific angle via a stepping motor.

10. A detecting system for detecting angular information of an optical disc, comprising:
a wobble signal detecting apparatus, for detecting a wobble signal of the optical disc;
a reference clock signal generating apparatus, coupled to the wobble signal detecting apparatus, for generating a reference clock signal according to the wobble signal; and
a phase comparator, coupled to the wobble signal detecting apparatus and the reference clock signal generating apparatus, for comparing the wobble signal and the reference clock signal to obtain the angular information of the optical disc.

11. The detecting system of claim 10, wherein the wobble signal detecting apparatus is an optical head.

12. The detecting system of claim 10, wherein the wobble signal includes a phase corresponding to an angle of the optical disc.

13. The detecting system of claim 12, wherein a starting point of the wobble signal corresponds to the phase.

14. The detecting system of claim 12, wherein the optical disc is generated from a stamper having angular information.

15. The detecting system of claim 14, wherein the stamper is generated by exposing, developing and etching a substrate having photo resistance thereon when the substrate is rotated to a specific angle via a stepping motor.

16. A detecting method for detecting angular information of an optical disc, comprising:
detecting a wobble track of the optical disc to generate a wobble signal;
generating a reference clock signal according to the wobble signal; and
comparing the wobble signal and the reference clock signal to obtain the angular information of the optical disc.

17. The detecting method of claim 16, wherein the wobble signal includes a phase corresponding to an angle of the optical disc.

18. The detecting method of claim 17, wherein a starting point of the wobble signal corresponds to the phase.

19. The detecting method of claim 17, wherein the optical disc is generated from a stamper having angular information.

20. The detecting method of claim 19, wherein the stamper is generated by exposing, developing and etching a substrate having photo resistance thereon when the substrate is rotated to a specific angle via a stepping motor.

21. A detecting method for detecting angular information of an optical disc, comprising:
detecting a wobble signal of the optical disc;
generating a reference clock signal according to the wobble signal; and
comparing the wobble signal and the reference clock signal to obtain the angular information of the optical disc.

22. The detecting method of claim 21, wherein the wobble signal includes a phase corresponding to an angle of the optical disc.

23. The detecting method of claim 22, wherein a starting point of the wobble signal corresponds to the phase.

24. The detecting method of claim 22, wherein the optical disc is generated from a stamper having angular information.

25. The detecting method of claim 24, wherein the stamper is generated by exposing, developing and etching a substrate having photo resistance thereon when the substrate is rotated to a specific angle via a stepping motor.
